(19) United States
(12) Patent Application Publication
(10) Pub. No.: US 2016/0119233 A1
(43) Pub. Date: Apr. 28, 2016

(54) METHOD AND SYSTEMS FOR SEAMLESS MEDIA TRANSITION BETWEEN NETWORKS

(71) Applicant: VONAGE NETWORK LLC, Holmdel, NJ (US)

(72) Inventors: Itay Bianco, Tel-Aviv (IL); Royee Tichauer, Haifa (IL); Sagi Iltus, Hadera (IL); Mark Wootton, Wall, NJ (US); Jaya Meghani, Old Bridge, NJ (US)

(21) Appl. No.: 14/524,581

(22) Filed: Oct. 27, 2014

(51) Int. Cl. H04L 12/741; H04L 29/12; H04L 12/823

(52) U.S. Cl. CPC H04L 45/74; H04L 47/32; H04L 61/2007

(57) ABSTRACT

Methods and systems for forwarding data packets containing media of an Internet protocol (IP) communication are provided herein. In some embodiments, a method for forwarding data packets containing media of an IP communication may include receiving IP communication setup signaling that includes an indication of a first originating IP address for data packets that are to be forwarded to a destination address; setting the first originating IP address as an authorized originating IP address; receiving a data packet from a second originating IP address directed to the destination address; and determining whether to forward the data packet from the second originating IP address to the destination address based on whether a first pre-defined time interval has elapsed since a last data packet was received from the first originating IP address.

### BACKGROUND

1. Field

Embodiments of the present invention generally relate to methods and systems for seamless media transition between networks.

2. Description of the Related Art

When an Internet Protocol (IP) telephony system establishes a VoIP telephone call between a calling telephony device and a called telephony device, it is common for data packets bearing the call setup signaling to traverse a first path between the calling telephony device and the called telephony device, and for data packets bearing the media of the call to traverse a second path between the calling telephony device and the called telephony device. Often, the IP telephony system will designate a media relay that is in direct communication with the calling and called telephony devices to pass data packets bearing the media back and forth between the calling and called telephony devices.

When a media relay is used to help communicate the data packets bearing the media of a call, the IP telephony system designates a specific port of the media relay for this purpose. The call setup signaling sent to the calling and called telephony devices informs the calling and called telephony devices of the IP address and designated port of the media relay so that the calling and called telephony devices know where to send data packets bearing the media of the call. Once the call commences, the designated port of the media relay receives data packets from both the calling and called telephony device and begins forwarding those packets between the calling and called telephony devices.

Due to the nature of mobile devices, a mobile device may change its location during the telephone call. For example, a call starting on a first network may move to a second network (for example, from a 3G cellular network to a wireless local area network (WLAN), from a 3G cellular network to a 4G cellular network, from a first WLAN to a second WLAN, etc.) resulting in data packets being received at the media relay from a different IP address than the IP address originally designated in the call signaling. In addition, stationary devices as well as devices that rely on various unreliable connections, such as Virtual Private Network (VPN), satellite, mobile hotspots, and the like may lose their network connection.

Currently, the media relay may accept data packets unconditionally from an unverified source exposing the media relay to unauthorized use. Alternatively, the media relay does not accept data packets from a different IP address until a session initiation protocol (SIP) REINVITE message is received. The REINVITE message causes the media relay to clear and reset the originating IP address so the media relay accepts data packets from the IP address. However, waiting for the REINVITE message takes time, resulting in a delay or possible loss of media during a transition between networks.

Thus, there is a need for a method and system for seamless media transition between networks.

### SUMMARY

Methods and systems for forwarding data packets containing media of an Internet protocol (IP) communication are provided herein. In some embodiments, a method for forwarding data packets containing media of an IP communication may include receiving IP communication setup signaling that includes an indication of a first originating IP address for data packets that are to be forwarded to a destination address; setting the first originating IP address as an authorized originating IP address; receiving a data packet from a second originating IP address directed to the destination address; and determining whether to forward the data packet from the second originating IP address to the destination address based on whether a first pre-defined interval has elapsed since a last data packet was received from the first originating IP address.

In some embodiments, a system for forwarding data packets containing media of an Internet protocol (IP) communication may include a communication setup unit configured to receive IP communication setup signaling that includes an indication of a first originating IP address for data packets that are to be forwarded to a destination address; an IP address setting unit configured to set the first originating IP address as an authorized originating IP address; a data packet handling unit configured to receive a data packet from a second originating IP address directed to the destination address; and to determine whether to forward the data packet from the second originating IP address to the destination address based on whether a first pre-defined interval has elapsed since a last data packet was received from the first originating IP address.

In some embodiments, a computer readable medium is disclosed. The computer readable medium stores computer instructions that, when executed by at least one processor causes the at least one processor to perform the method for forwarding data packets containing media of an IP communication.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 illustrates elements of a computer processor that can be used as part of the IP telephony system to accomplish various functions, according to one or more embodiments of the invention;

FIG. 3 illustrates how a call is connected between a calling IP telephony device and a called IP telephony device utilizing a media relay, according to one or more embodiments of the subject invention;

FIG. 4 illustrates some of the elements that are present in a media relay, according to one or more embodiments of the subject invention; and

FIG. 5 depicts a flow diagram of a method for forwarding data packets containing media of a voice over Internet protocol (VoIP) communication, according to one or more embodiments of the subject invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for seamless media transition between networks. More specifically, when a media relay receives a data packet from a new IP address that is different from the originating IP address specified in signaling when a call is setup, embodiments of the present invention facilitate temporarily allowing data packets from the new IP address until the media relay resets the authorized port from where the media can be received, for example via a SIP REINVITE. The details and functionality of SIP can be found in the Internet Engineering Task Force (IETF) Request for Comments (RFC) Paper No. 3261 entitled, “SIP: Session Initiation Protocol,” that is herein incorporated in its entirety by reference. Although the present disclosure is described using a SIP REINVITE message, any type of message may be used, such as a SIP UPDATE, SIP INFO, SIP MESSAGE, H323, or XMPP message, and the like.

In some embodiments, after a call is established between a calling device and a callee device, via SIP signaling for example, media packets are received at the media relay from the originating IP addresses of each device. When the location of one of the client devices moves to a different network, media packets (from the client device that moved) are received at the media relay from a new IP address. If media packets are no longer being received from the originating IP address (e.g., if no packet has been received from the originating IP address in X ms), the media relay locks on to the new IP address and forwards the received media packets for a pre-defined period of time. If within the pre-defined period of time no new REINVITE message arrives specifying/authenticating the new IP address, the media relay discards media packets from the new IP address and reverts to receiving media packets from the originating IP address.

In some embodiments, after a call is established between a calling device and a callee device, media packets are received at the media relay from the originating IP address. An identifier, for example a synchronization source identifier (SSRC), is stored for the media packets. The SSRC is received in a header of each media packet. When the location of one of the client device moves to a different network, media packets are received at the media relay from a new IP address. Two criteria are evaluated. First, it is determined whether media packets are no longer being received from the originating IP address (e.g., a timestamp indicating when the last media packet was received indicates that no packet has been received from the originating IP address in X ms). Second, it is determined whether the SSRC of the media packet from the new IP address matches the SSRC of media packets received from the originating IP address. If both criteria are met, the media relay locks on to the new IP address and forwards the received media packets for a pre-defined period of time. Optionally, if within the pre-defined period of time no new REINVITE message arrives specifying the new IP address, the media packet discards media packets from the new IP address and reverts to receiving media packets from the originating IP address. However, due to the matching SSRCs, no further authentication may be required and media packets continue to be forwarded regardless of whether a new REINVITE message is received. The steps described above are performed each time either or both the calling device or callee device move to a different network.

Although the present disclosure describes the invention using an exemplary embodiment of forwarding data packets bearing the media of a Voice over Internet Protocol (VoIP) telephony communication, one skilled in the art can appreciate that the present invention may be used for any session-based IP communication that has a signaling channel, a media channel, and a media relay, such as Internet Relay Chat (IRC), Simple Mail Transfer Protocol (SMTP), and the like or additionally for use in resumable file download or one-way video streaming.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text, audio, and video communications using Internet protocol data communications. Those of ordinary skill in the art will recognize that embodiments of the present invention are not limited to use with IP telephony systems and may also be used in other systems.

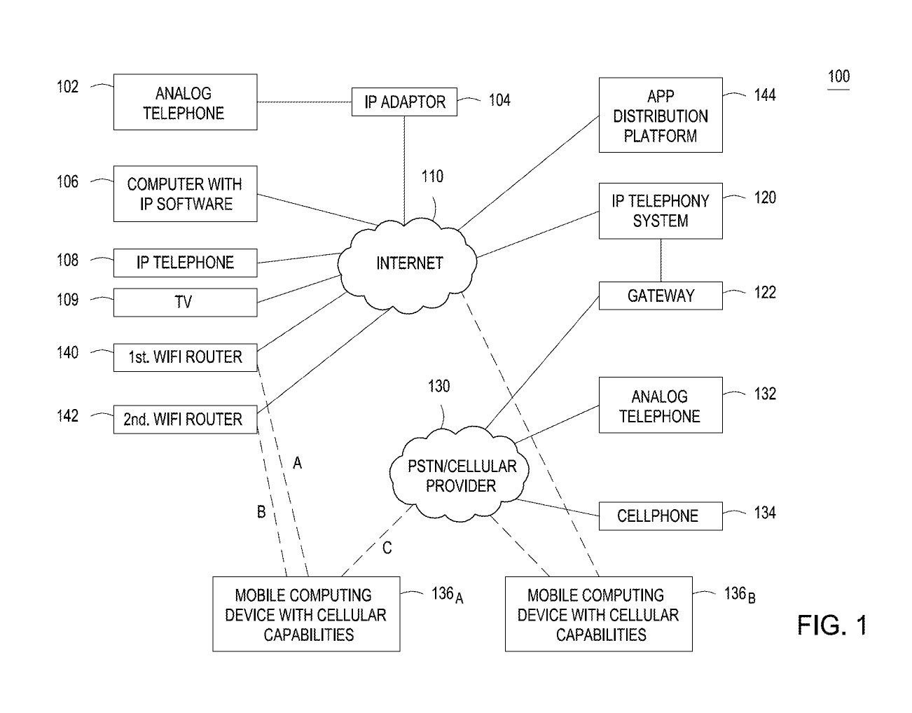

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a wireless local area network (WLAN) router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136B may also be coupled to internet 110 and/or cellular service provider 130. In some embodiments, mobile computing device 136B may be connected to internet 110 via a wireless local area network (WLAN) based on the Institute of Electrical and Electronics Engineers' (IEEE) 802.11 and 802.13 standard connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

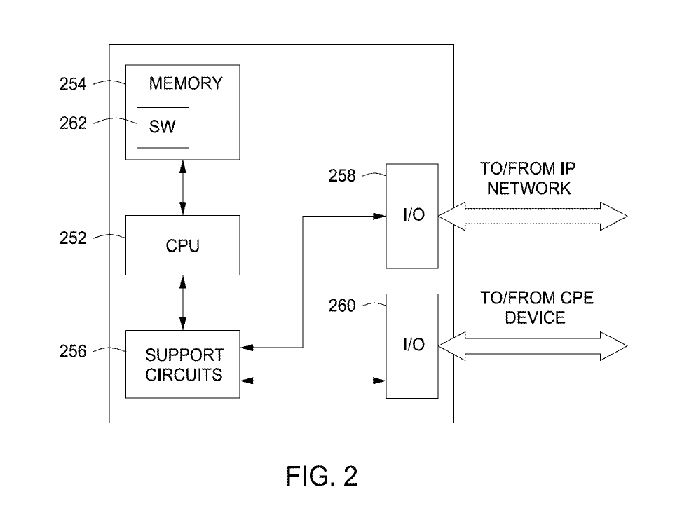

FIG. 2 illustrates elements of a computer processor 250 that can be used as part of the IP telephony system 120 to accomplish various functions. The IP telephony system 120 could include multiple processors 250 located at various locations in the system, along with their operating components and programming, each carrying out a specific or dedicated portion of the functions performed by the VoIP based telephony service 120. Further, a mobile telephony device 136 or some other IP telephony device could make use of one or more of the processors 250 to accomplish various functions.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment and to service provider agent equipment, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120, or a mobile telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture

The following description refers to IP telephony communications, or simply telephony communications. This phrase is intended to encompass any type of communication, including voice or video telephone calls, text messages and other forms of text-based, voice-based, or video-based messaging, as well as other forms of communications. Although the following examples may refer to a “call” or a “telephone call,” for ease of reference, clarity and brevity, the systems and methods described may also be used to accomplish other forms of communications.

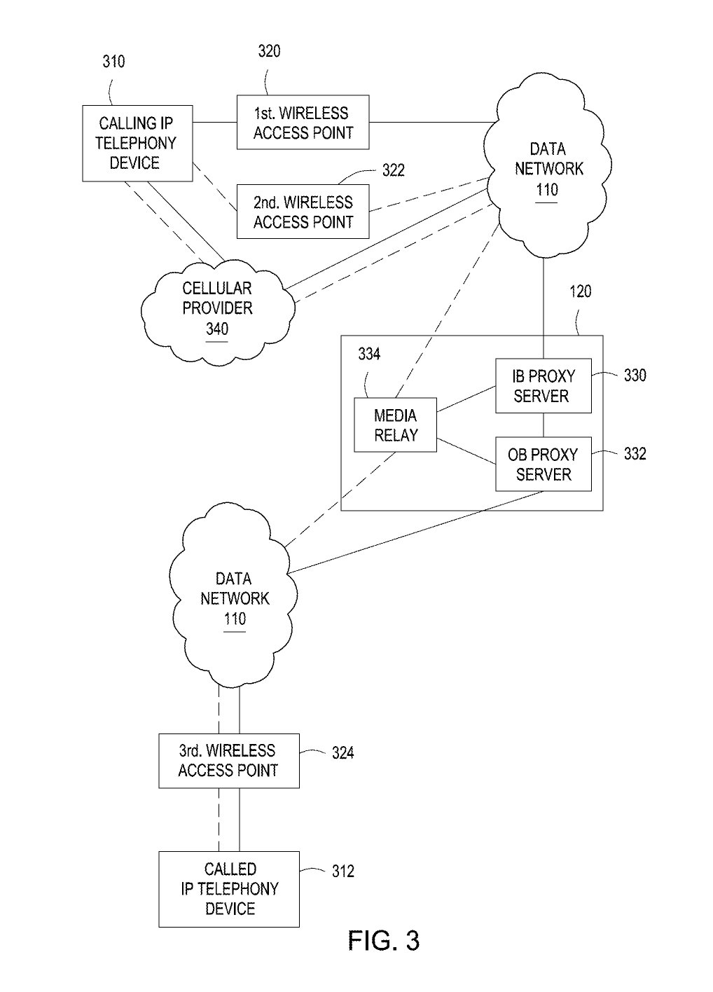

FIG. 3 illustrates one embodiment of how a call is connected between a calling IP telephony device 310 and a called IP telephony device 312 utilizing a media relay 334. The following description also explains how systems and methods embodying the invention can allow the data packets bearing the media of the call to originate from a different IP address than the data packets bearing the call setup signaling. Call setup signaling may include various types of IP signaling protocols, such as SIP, Real-Time Transport Protocol (RTP), Hyper Text Transfer Protocol (HTTP), and the like. In FIG. 3, the paths traversed by data packets bearing call setup signaling are illustrated by solid lines. The paths traversed by data packets bearing the media of a call are illustrated by dashed lines.

In an embodiment illustrated in FIG. 3, when the user of the calling IP telephony device 310 dials the telephone number of the called IP telephony device 312, call setup signaling is transmitted to the IP telephony system 120 via the data network 110. In this embodiment, the call setup signaling passes through a first data channel established between the calling IP telephony device 310 and the data network 110 through the first wireless access point 320. The call setup signaling is received by media relay 334 of the IP telephony system 120.

The called IP telephony device 312 is a mobile IP telephony device that establishes a data connection to a data network 110 through a third wireless access point 324. When a call is first setup between the calling IP telephony device 310 and the called IP telephony device 312, call setup signaling is routed from the inbound proxy server 330 and the outbound proxy server 332 of the IP telephony system 120 to the called IP telephony device 312 via the third wireless access point 324. Data packets bearing the media of the call are routed through the media relay 334 of the IP telephony system 120 directly to the third wireless access point 324, which delivers the data packets to the called IP telephony device 312. Likewise, data packets bearing the media of the call that are generated by the called IP telephony device 312 are routed through the third wireless access point 324 directly to the media relay 334 via the data network 110. Thus, data packets bearing the media of the call and data packets bearing the call setup signaling are routed to and from the called IP telephony device via the same wireless data connection to the called IP telephony device 312.

During call setup, the media relay 334 is informed of the IP address of the third wireless access point 324, from which call setup signaling from the called IP telephony device 312 originates. The media relay 334 would be instructed to expect to receive data packets bearing the media of the call and sent from the called IP telephony device 312, where those data packets have the originating IP address of the third wireless access point 324. Because the called IP telephony device 312 communicates both call setup signaling and media through the third wireless access point 324, this information would be accurate.

Although a call is established to a called telephony device 312 via a first path, the path may change partway through the call. This could occur if the calling mobile telephony device 310 is moving, and it moves out of range of a first wireless access point 320 and into range of a second wireless access point 322. When this occurs the call would be switched from the first wireless access point 320 to the second wireless access point 322 partway through the call. Because the wireless access points have different IP addresses, the originating IP address of the data packets sent from the calling IP telephony device 310 would change partway through the call. Likewise, data packets that are to be sent to the called IP telephony device 310 must be addressed to a different IP address after the transition occurs.

The media relay 334 is configured to allow a transition to a different network. When the calling IP telephony device 310 begins sending data packets bearing the media of the call to the identified port of the media relay 334, via the second wireless access point 322, those data packets will have the originating IP address of the second wireless access point 322. When this occurs, the media relay 334 determines whether media packets are no longer being received from the originating IP address of the first wireless access point 320. If no media packets were received from the originating IP address of the first wireless access point 320 in a predefined period of time, for example, X ms, the media relay 334 changes the authorized originating IP address for the call from the IP address of the first wireless access point 320 to the IP address of the second wireless access point 322. The predefined period of time may be adjusted or configured on the media relay. In some embodiments, the media relay 334 also determines whether the synchronized source identifier (SSRC) of media packets received from the originating IP address of the second wireless access point 322 matches the SSRC of media packets received from the originating IP address of the first wireless access point 320. Although we refer to SSRC as a source identifier, one skilled in the art will recognize that any source identifier could be utilized, for example a call ID assigned by the network, for example upon call initiation, a caller ID of a caller/call, and account ID of the caller/callee, and the like.

If no media packets were received from the originating IP address of the first wireless access point 320 within the first pre-defined timeout period, and the SSRC of media packets received from the originating IP address of the second wireless access point 322 match the SSRC of media packets received from the originating IP address of the first wireless access point 320, then for a second pre-defined period of time, the assigned port of the media relay 334 will accept and forward data packets having the originating IP address of the second wireless access point 322.

However, if the media relay 334 does not receive authentication, such as an SIP REINVITE message, within the second pre-defined period of time, the media relay 334 will refuse to forward data packets having the originating IP address of the second wireless access point 322 and will revert to forwarding data packets received from the originating IP address of the first wireless access point 320. In some embodiments, a message may be sent back to the IP address from where the packet was received indicating that the media packet was not forwarded. The call signaling that occurs during a REINVITE action informs the media relay of the change in the IP address being used by the mobile telephony device and can be used to authenticate the sender of the media packets. In some embodiments, the REINVITE message includes the IP/port information that the media relay may use for comparison in order to authenticate the sender. In some embodiments, a proprietary call identifier or key may be sent to the media relay, which the media relay may use for comparison in order to authenticate the sender.

During a REINVITE action, the media relay 334 would be informed of the new originating IP address of the mobile telephony device. Specifically, the media relay 334 would be informed of the new address used by the calling mobile telephony device 310 to communicate the signaling associated with the REINVITE action. The REINVITE message causes the media relay to reset the IP address/port from where it receives media.

Temporarily allowing a change to the authorized originating IP address for the data packets bearing the media of the call until a REINVITE message is received ensures that data packets sent from the calling IP telephony device 310 via a second wireless data connection (which is different from a first wireless data connection used to communicate the original call setup signaling) will still be forwarded on to the called IP telephony device 312. In some embodiments, where the SSRC of media packets received from the originating IP address of the second wireless access point 322 match the SSRC of media packets received from the originating IP address of the first wireless access point 320, a REINVITE may not be required and the media relay 334 continues to forward media packets received from the originating IP address of the second wireless access point 322.

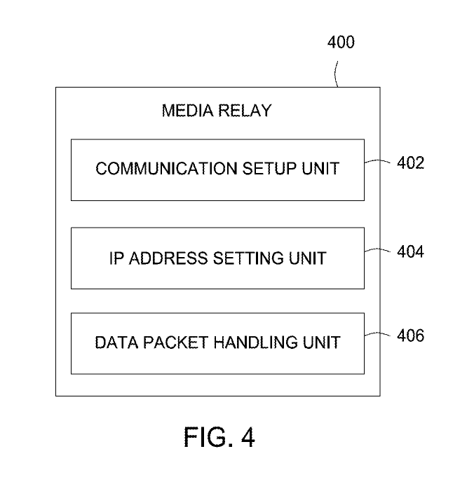

FIG. 4 illustrates some of the elements that are present in a media relay 400, according to one or more embodiments of the present invention. The media relay 400 includes a communication setup unit 402 which handles call setup signaling sent from a proxy server or other elements of the IP telephony system 120. The communication setup unit 402 reserves a particular port of the media relay 400 for use in communicating data packets bearing the media of a call.

The media relay 400 also includes an IP address setting unit 404. The IP address setting unit 404 identifies the authorized originating IP addresses from which a particular port of the media relay 400 will receive and forward data packets bearing the media of a call. When a call is first being setup, the IP address setting unit 404 sets the authorized originating IP addresses to the IP addresses from which call setup signaling was received from the calling and called telephony devices. However, as explained above, in some embodiments, if a REINVITE action is not received within a predefined time interval, the IP address setting unit 404 may reset the authorized originating IP address to a prior IP address where media was received.

The media relay 400 also includes a data packet handling unit 406. The data packet handling unit 406 receives incoming data packets and forwards those data packets to the proper destination under the proper circumstances. As explained above, if a received data packet has an originating IP address that is valid, according to the IP address setting unit, the data packet handling unit 406 forwards the data packet to the appropriate destination. If the data packet handling unit 406 is receiving data packets from a first originating IP address, and data packets are received from a second IP address, the data packet handling unit 406 discards the data packet. If the data packet handling unit 406 is receiving data packets from a first originating IP address with each data packet having a synchronized source identifier (SSRC) and a data packet is received from a second IP address and the data packet has a SSRC different from the SSRC of the packets received from the first IP address, the data packet handling unit 406 discards the data packet.

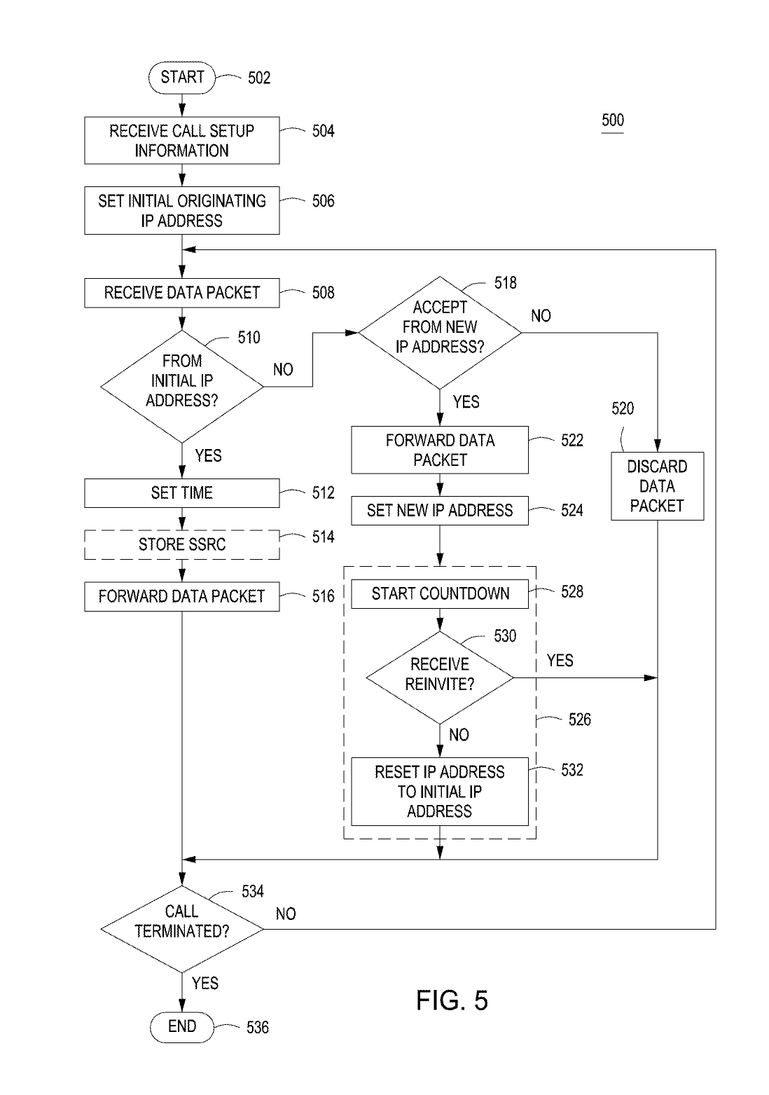

FIG. 5 depicts a flow diagram of a method 500 for forwarding data packets containing media of a voice over Internet protocol (VoIP) communication, according to one or more embodiments of the subject invention. The method 500 starts at step 502 and proceeds to step 504, where the communication setup unit 402 of a media relay 400 receives call setup information. The call setup information indicates the originating IP address of the data packets bearing the call setup signaling that was sent from the calling telephony device. In some embodiments, the call setup information may also indicate the originating IP address of the data packets bearing call setup signaling sent from the called telephony device.

At step 506 the IP address setting unit 404 sets the initial originating IP addresses for data packets bearing the media of the call which are to be sent from the calling and called telephony devices. The initial originating IP addresses are identical to the originating IP addresses of the call setup signaling received from the calling and called IP telephony devices. The IP address of the call setup signaling may be different from the IP address of the media. In such case, the IP address that will bear the media of the call is communicated within the signaling, but may not be the signaling IP address itself.

At step 508, the media relay receives a first data packet bearing the media of the call from one of the calling and called telephony devices. At step 510, the data packet handling unit 406 checks to determine if the originating IP address of the data packet matches the originating IP addresses set for that telephony device. If so, the method proceeds to step 512, where a means of determining the time that the data packet was received is stored. In some embodiments, a timer is set. The timer will run until another data packet is received. The time will be used to determine how much time has passed since a previous data packet was received from the IP address. In some embodiments, a timestamp is recorded when the data packet is received and later used to determine how much time has passed since a previous data packet was received from the IP address.

Optionally, at step 514 a synchronization source identifier (SSRC) for the media packet is stored. The SSRC is stored in the header of the data packet and uniquely identifies the source of the data packet. At step 516, the data packet is forwarded to the appropriate destination and the method proceeds to step 534.

However, if at step 510, it is determined that the originating IP address of the data packet does not match the originating IP addresses set for that telephony device, then the data packet handling unit 406 determines whether the data packet should be forwarded from this new IP address. At 518, the data packet handling unit determines how long it has been since a data packet was received from the initial originating IP address. If the time since a data packet was received from the initial originating IP address does not exceed a pre-defined threshold, for example X ms, then at step 520, the data packet handling unit 406 discards the data packet and the method proceeds to step 534.

However, if at 518, it is determined that the time since a data packet was received from the initial originating IP address exceeds the pre-defined threshold, then it is determined that media is no longer being received from the initial originating IP address (i.e., the mobile device has moved to a different network). As such, the data packet may be forwarded. In some embodiments, at step 518, in addition to determining whether to accept/forward media from a new IP address based on the time period from the last packet received from the initial originating IP address, it is determined whether the SSRC of the data packet received from the new IP address matches the SSRC of the data packets received from the initial originating IP address. If the SSRC does not match, the data packet is discarded at step 520. Otherwise, at step 522, the data packet is forwarded to the appropriate destination.

At step 524, the IP address setting unit 404 sets the new IP address as an appropriate originating IP address. In some embodiments, the new IP address is stored temporarily and the method optionally proceeds to block 526. In such embodiments, as an additional security measure, the new IP address is not stored as the originating IP address until a SIP REINVITE message is received within a pre-defined interval. At step 528, a countdown timer is started as a background process. While the timer counts down, data packets may continue to be received from the new IP address. When the timer runs down to zero, at step 530, it is determined whether a SIP REINVITE message was received. If the REINVITE message was received, the IP address setting unit stores the new IP address as an appropriate originating IP address and the method proceeds to step 534. However, if the REINVITE message is not received by the time the timer runs down to zero, then the method proceeds to step 532 where the IP address setting unit discards the new IP address and resets the initial originating IP address as an appropriate originating IP address and the method proceeds to step 534.

Block 526 is optional because if the SSRC of the data packets received from the new IP address match the SSRC of the data packets received from the initial originating IP address, no further authentication may be required in some embodiments and the REINVITE message is deemed unnecessary. However, if the only indication that the data packets from the new IP address are authentic is that no data packets were received from the initial originating IP address for more than X ms, further authentication is needed and the REINVITE message may be deemed necessary.

At step 534, the media relay determines whether the call has terminated. If not, the method proceeds to step 508 and iterates until the media relay determines that the call has terminated at which time the method ends at step 536.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for forwarding data packets containing media of an Internet protocol (IP) communication, comprising:
receiving IP communication setup signaling that includes an indication of a first originating IP address for data packets that are to be forwarded to a destination address;
setting the first originating IP address as an authorized originating IP address;
receiving a data packet from a second originating IP address directed to the destination address; and
determining whether to forward the data packet from the second originating IP address to the destination address based on whether a first pre-defined time interval has elapsed since a last data packet was received from the first originating IP address.

2. The method of claim 1, further comprising:
forwarding the data packet to the destination address when it is determined that no data packet was received from the first originating IP address within the first pre-defined time interval.

3. The method of claim 1, further comprising:
determining whether a source identifier of the data packet received from the second originating IP address matches the source identifier of a data packet received the first originating IP address; and
forwarding the data packet to the destination address when it is determined that no data packet was received from the first originating IP address within the first pre-defined time interval and when it is determined that the source identifier of the data packet received from the second originating IP address matches the source identifier of a data packet received the first originating IP address.

4. The method of claim 1, further comprising:
determining whether a source identifier of the data packet received from the second originating IP address matches the source identifier of a data packet received the first originating IP address; and
discarding the data packet when it is determined that the source identifier of the data packet received from the second originating IP address does not match the source identifier of a data packet received the first originating IP address.

5. The method of claim 1, further comprising:
setting the second originating IP address as the authorized originating IP address;
forwarding data packets received from the second originating IP address; and
resetting the first originating IP address as the authorized originating IP address when a session initiation protocol (SIP) REINVITE message is not received from the second originating IP address within a second pre-defined time interval.

6. The method of claim 1, further comprising discarding the data packet when it is determined that a data packet was received from the first originating IP address within the first pre-defined time interval.

7. The method of claim 1, wherein the method is performed by a media relay.

8. The method of claim 1, wherein forwarding the data packet comprises forwarding the data packet to a destination IP address identified in the IP communication setup signaling.

9. A system for forwarding data packets containing media over an Internet protocol (IP) communication, comprising:
a communication setup unit configured to receive IP communication setup signaling that includes an indication of a first originating IP address for data packets that are to be forwarded to a destination address;
an IP address setting unit configured to set the first originating IP address as an authorized originating IP address;
a data packet handling unit configured to receive a data packet from a second originating IP address directed to the destination address; and to determine whether to forward the data packet from the second originating IP address to the destination address based on whether a first pre-defined time interval has elapsed since a last data packet was received from the first originating IP address.

10. The system of claim 9, wherein the data packet handling unit is further configured to forward the data packet to the destination address when it is determined that no data packet was received from the first originating IP address within the first pre-defined time interval.

11. The system of claim 9, wherein the data packet handling unit is further configured to:
determine whether a source identifier of the data packet received from the second originating IP address matches the source identifier of a data packet received the first originating IP address; and
forward the data packet to the destination address when it is determined that no data packet was received from the first originating IP address within the first pre-defined time interval and when it is determined that the source identifier of the data packet received from the second originating IP address matches the source identifier of a data packet received the first originating IP address.

12. The system of claim 9, wherein the data packet handling unit is further configured to:
determine whether a source identifier of the data packet received from the second originating IP address matches the source identifier of a data packet received the first originating IP address; and
discard the data packet when it is determined that the source identifier of the data packet received from the second originating IP address does not match the source identifier of a data packet received the first originating IP address.

13. The system of claim 9, wherein the IP address setting unit is further configured to set the second originating IP address as the authorized originating IP address.

14. The system of claim 13, wherein the data packet handling unit is further configured to:
forward data packets received from the second originating IP address; and
reset the first originating IP address as the authorized originating IP address when a session initiation protocol (SIP) REINVITE message is not received from the second originating IP address within a second pre-defined time interval.

15. The system of claim 9, wherein the data packet handling unit is further configured to discard the data packet when it is determined that a data packet was received from the first originating IP address within the first pre-defined time interval.

16. The system of claim 9, wherein the communication setup unit, the IP address setting unit, and the data packet handling unit are part of a media relay.

17. A non-transitory computer readable medium for storing computer instructions that, when executed by at least one processor causes the at least one processor to perform a method for forwarding data packets containing media of an Internet protocol (IP) communication, comprising:
receiving IP communication setup signaling that includes an indication of a first originating IP address for data packets that are to be forwarded to a destination address;
setting the first originating IP address as an authorized originating IP address;
receiving a data packet from a second originating IP address directed to the destination address; and
determining whether to forward the data packet from the second originating IP address to the destination address based on whether a first pre-defined time interval has elapsed since a last data packet was received from the first originating IP address.

18. The computer readable medium of claim 17, further comprising:
forwarding the data packet to the destination address when it is determined that no data packet was received from the first originating IP address within the first pre-defined time interval.

19. The computer readable medium of claim 17, further comprising:
determining whether a source identifier of the data packet received from the second originating IP address matches the source identifier of a data packet received the first originating IP address; and
performing one of forwarding the data packet to the destination address when it is determined that no data packet was received from the first originating IP address within the first pre-defined time interval and when it is determined that the source identifier of the data packet received from the second originating IP address matches the source identifier of a data packet received the first originating IP address or discarding the data packet when it is determined that the source identifier of the data packet received from the second originating IP address does not match the source identifier of a data packet received the first originating IP address.

20. The computer readable medium of claim 17, further comprising:
setting the second originating IP address as the authorized originating IP address;
forwarding data packets received from the second originating IP address; and
resetting the first originating IP address as the authorized originating IP address when a session initiation protocol (SIP) REINVITE message is not received from the second originating IP address within a second pre-defined time interval.
